(19) United States
(12) Patent Application Publication
(10) Pub. No.: US 2022/0248114 A1
(43) Pub. Date: Aug. 4, 2022

(54) BUILDING MATERIAL

(71) Applicant: Panasonic Intellectual Property Management Co., Ltd., Osaka (JP)

(72) Inventors: Akihisa KAWAMURA, Osaka (JP); Shuji SAIKI, Nara (JP); Satoshi TAKAYAMA, Mie (JP)

(21) Appl. No.: 17/728,329

(22) Filed: Apr. 25, 2022

Related U.S. Application Data
(63) Continuation of application No. PCT/JP2020/040043, filed on Oct. 26, 2020.
(60) Provisional application No. 62/927,989, filed on Oct. 30, 2019.

(30) Foreign Application Priority Data
Apr. 9, 2020 (JP) 2020-070628

(51) Int. Cl. H04R 1/02

(52) U.S. Cl. CPC H04R 1/023; H04R 1/025

(57) ABSTRACT

A building material facing a first space includes a structure which is in a plate form and includes at least one opening; a first loudspeaker disposed in a second space across the structure from the first space, in a position opposite to a corresponding one of the at least one opening; and a three-dimensional netlike structure disposed between the structure and the first loudspeaker and configured with a fibrous member three-dimensionally intertwined.

### CROSS REFERENCE TO RELATED APPLICATIONS

This is a continuation application of PCT International Application No. PCT/JP2020/040043 filed on Oct. 26, 2020, designating the United States of America, which is based on and claims priority of U.S. Provisional Patent Application No. 62/927,989 filed on Oct. 30, 2019 and Japanese Patent Application No. 2020-070628 filed on Apr. 9, 2020. The entire disclosures of the above-identified applications, including the specifications, drawings and claims are incorporated herein by reference in their entirety.

### FIELD

The present disclosure relates to a building material.

### BACKGROUND

PTL 1 discloses a loudspeaker system which is attachable to ceiling panels of bathroom units and which includes a decoration cover covering the sound radiation surface of a loudspeaker unit.

### CITATION LIST

### Patent Literature

PTL 1: Japanese Unexamined Patent Application Publication No. 2005-143900

### SUMMARY

### Technical Problem

It is desired that a building material for ceilings and wall surfaces to which a loudspeaker is attached can ensure both an improved appearance of the building material and improved acoustic performance of sounds radiated from the loudspeaker at the same time.

An object of the present disclosure is to provide a building material which can ensure an improved appearance and improved acoustic performance of sounds radiated from a loudspeaker.

### Solution to Problem

The building material according to one aspect of the present disclosure is a building material facing a first space, the building material including: a structure which is in a plate form and includes at least one opening; a first loudspeaker disposed in a second space across the structure from the first space, in a position opposite to a corresponding one of the at least one opening; and a three-dimensional netlike structure disposed between the structure and the first loudspeaker, and is configured with a fibrous member three-dimensionally intertwined.

### Advantageous Effects

The building material according to the present disclosure can ensure both an improved appearance of the building material and improved acoustic performance of sounds radiated from the loudspeaker at the same time.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of installation of a building material.

FIG. 2 is a perspective view of the appearance of the building material viewed from above.

FIG. 3 is a perspective view of the appearance of the building material viewed thereunder.

FIG. 4 is a cross-sectional view of the building material taken along Iv-Iv in FIG. 2.

FIG. 5 is a graph showing the acoustic properties of the building material.

FIG. 6 is a diagram illustrating an example of installation of the building material according to Modification 4.

FIG. 7 is a perspective view of the appearance of the building material according to Modification 5.

FIG. 8 is a perspective view of the appearance of the building material according to Modification 5 from which part of foliage plants is removed.

FIG. 9 is a perspective view of the appearance of the building material in another form according to Modification 5, which is viewed from the front thereof.

FIG. 10 is a perspective view of the appearance of the building material in another form according to Modification 5 viewed from a lateral surface side, where part of the foliage plants is removed.

### DESCRIPTION OF EMBODIMENT

### (Underlying Knowledge Forming Basis of the Present Disclosure)

The loudspeaker system according to PTL 1 includes a loudspeaker unit covered with a decoration cover. Such a configuration can reduce the visibility of the loudspeaker unit in the loudspeaker system from a person. Thus, it is considered that such a configuration provides an effect of improving the appearance of the loudspeaker system. In this loudspeaker system, the loudspeaker unit is covered with the decoration cover, thereby providing an effect of preventing direct contact of the loudspeaker unit by a person or an object.

However, these effects trade off the acoustic performance of the sounds radiated from the loudspeaker. For example, to provide a configuration which can further reduce the visibility of the loudspeaker unit from a person or prevent direct contact of the loudspeaker unit with a person or an object, the decoration cover should have an opening with a small area, which leads to a reduction in acoustic performance of the sounds radiated from the loudspeaker. In contrast, in attempts to improve the acoustic performance of the sounds radiated from the loudspeaker, the decoration cover should have an opening with a large area, which undesirably reduces the effect of reducing the visibility of the loudspeaker unit from the person or the effect of preventing direct contact of the loudspeaker unit with a person or an object.

Thus, the present inventors have found a building material which can ensure both an improved appearance of the building material and improved acoustic performance of sounds radiated from the loudspeaker at the same time, and also functions as a loudspeaker system.

According to an exemplary embodiment disclosed herein, the building material according to one aspect of the present disclosure includes a structure which is in a plate form and includes at least one opening; a first loudspeaker disposed in a second space across the structure from the first space, in a position opposite to a corresponding one of the at least one opening; and a three-dimensional netlike structure disposed between the structure and the first loudspeaker, and is configured with a fibrous member three-dimensionally intertwined.

With this, the three-dimensional netlike structure is disposed between the structure and the first loudspeaker, thus reducing the visibility of the first loudspeaker from a person. Due to its high acoustic transparency, the three-dimensional netlike structure, even when disposed in the front of the first loudspeaker, hardly reduces the acoustic performance of the first loudspeaker. This can ensure both an improved appearance of the building material and improved acoustic performance of sounds radiated from the loudspeaker at the same time.

Moreover, the three-dimensional netlike structure may have a surface of a second color having a color difference smaller than a predetermined threshold, the color difference being calculated with reference to a first color that a surface of the structure close to the first space has.

This can make the first loudspeaker less prominent, further improving the appearance of the building material.

Moreover, the three-dimensional netlike structure may include a material selected from the group consisting of a resin, a metal, and glass.

Moreover, the three-dimensional netlike structure may include a transparent or semi-transparent material.

Moreover, the building material may further include a light source disposed across the three-dimensional netlike structure from the structure, in a position opposite to a corresponding one of the at least one opening.

Thus, by emission from the light source, light can be radiated from the at least one opening to the first space. This can make the first loudspeaker less prominent, further improving the appearance of the building material.

Moreover, a volume of the three-dimensional netlike structure may be 10% or less of a volume of a third space occupied by the three-dimensional netlike structure.

Thus, the three-dimensional netlike structure can efficiently transmit sounds from the loudspeaker.

Moreover, the building material may further include a second loudspeaker disposed in the second space, in a position opposite to a corresponding one of the at least one opening. The three-dimensional netlike structure may be disposed between (1) the structure and (ii) the first loudspeaker and the second loudspeaker.

Thus, the appearance of the building material and the acoustic performance of sounds radiated from the first loudspeaker and the second loudspeaker can be improved at the same time.

Moreover, the first loudspeaker and the second loudspeaker may have a same reproduction bandwidth.

In such a configuration, for example, even when the radiated sounds are sounds from a sound source having multiple channels, the acoustic performance can be improved.

Moreover, the first loudspeaker and the second loudspeaker may have different reproduction bandwidths.

With this, even when the radiated sounds are sounds in a wider reproduction bandwidth, the acoustic performance can be improved.

Hereinafter, the building material according to one aspect of the present disclosure will be specifically described with reference to the drawings.

The embodiment described below is illustrative and one specific example of the present disclosure. Numeric values, shapes, materials, components, arrangements and positions of components, connections forms thereof, steps, orders of steps, and the like shown in the embodiment below are mere examples, and should not be construed as limitations to the present disclosure. Moreover, among the components of the embodiment below, the components not described in an independent claim representing the most superordinate concept of the present disclosure are described as optional components.

### EMBODIMENT

The configuration of the building material according to an embodiment will be described.

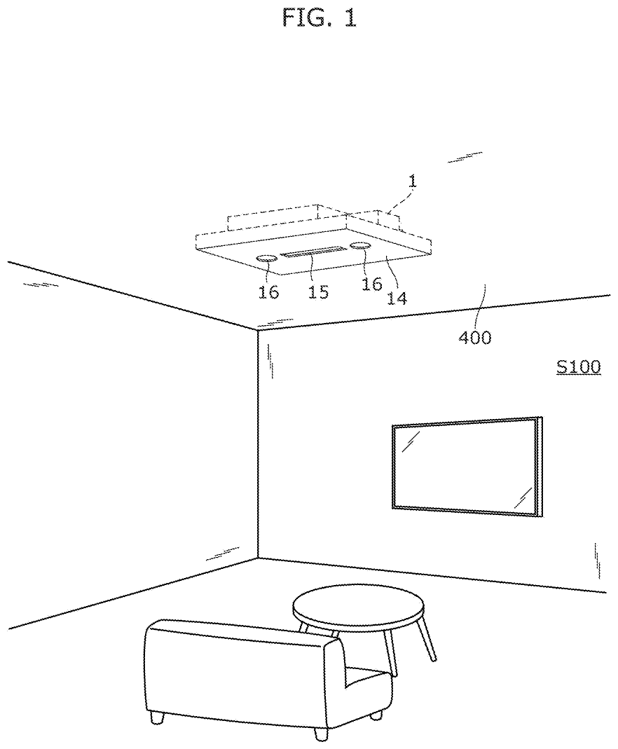

FIG. 1 is a diagram illustrating an example of installation of the building material.

As shown in FIG. 1, building material 1 installed is embedded in ceiling 400 of a room. Building material 1 defines part of ceiling 400, and faces room space S100. In other words, building material 1 includes structure 14 in a plate form disposed close to room space S100, structure 14 defining part of a surface of ceiling 400 in room space S100. For example, structure 14 in building material 1 and ceiling 400 in room space S100 may define a planar surface. Structure 14 includes openings 15 and 16. Building material 1 includes a loudspeaker inside thereof (see the description below), and sounds of the loudspeaker are radiated from openings 15 and 16 to room space S100. Room space S100 is one example of a first space.

Building material 1 may be installed not only on ceiling 400 but also on a different building material such as a wall or a floor such that building material 1 and the different building material define a planar surface in room space S100. The surface of structure 14 in building material 1 may be planar, or may be curved. In this case, structure 14 in building material 1 and ceiling 400 may also define a curved surface in room space S100. In other words, structure 14 may have a surface of any shape as long as it and ceiling 400 define a surface in room space S100.

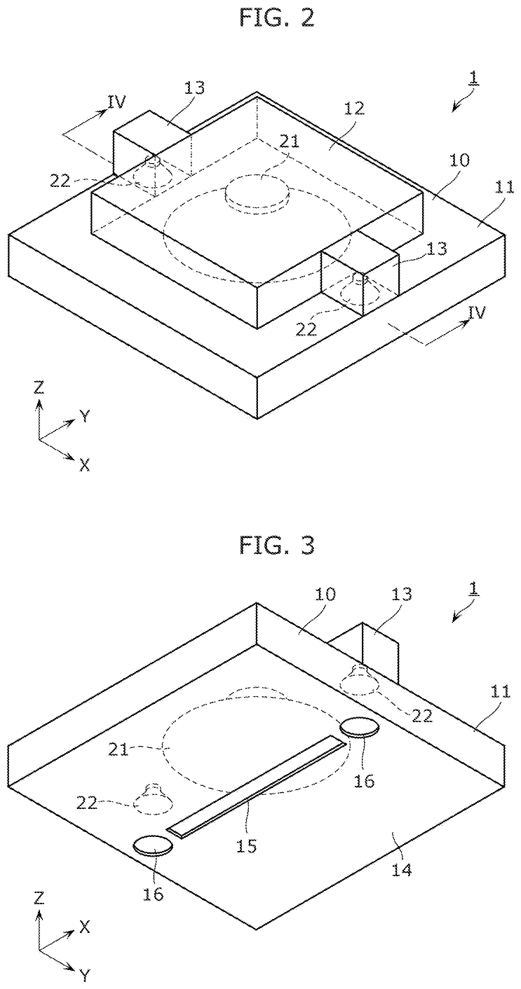

Next, a specific configuration of building material 1 will be described with reference to FIGS. 2 to 4.

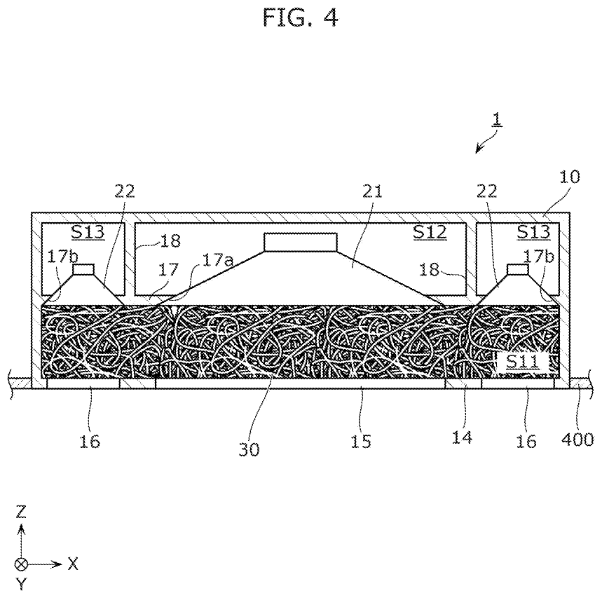

FIG. 2 is a perspective view of the appearance of the building material viewed from above. FIG. 3 is a perspective view of the appearance of the building material viewed from thereunder. FIG. 4 is a cross-sectional view of the building material taken along IV-IV in FIG. 2. In the present embodiment, the X-axial direction corresponds to the horizontal direction, the Y-axial direction corresponds to the transverse direction, and the Z-axial direction corresponds to the vertical direction. The X-axial direction, the Y-axial direction, and the Z-axial direction intersect perpendicular to each other. In the descriptions of the drawings, the arrow directions of the X-axial direction, the Y-axial direction, and the Z-axial direction are referred to a plus direction of each axis, and the opposite direction thereof is referred to as a minus direction of each axis.

Illustrated in these drawings, building material 1 includes housing 10 including openings 15 and 16, first loudspeaker 21 and second loudspeaker 22 disposed in an inner space of housing 10, and three-dimensional netlike structure 30. Building material 1 may further include an acoustically transparent covering material (not illustrated) which covers openings 15 and 16. The covering material may be a mesh cloth, for example.

Housing 10 includes first part 11, second part 12, and two third parts 13. Housing 10 includes a material such as a resin, metal, or wood material.

First part 11 defines inner space S11. Inner space S11 includes three-dimensional netlike structure 30. In the present embodiment, entire inner space S11 is filled with three-dimensional netlike structure 30. First part 11 includes structure 14 defining the surface on the side of the Z-axis minus direction. Inner space S11 has a shape of a substantially cuboid and is flat in the Z-axial direction. Inner space S11 may be a substantially cylindrical shape configured of circular bottom surfaces on both sides of the Z-axial direction and a flat portion in the Z-axial direction.

Here, three-dimensional netlike structure 30 is configured with a fibrous member three-dimensionally intertwined. Three-dimensional netlike structure 30 has a looped shape formed by winding a continuous linear body. Three-dimensional netlike structure 30 has a smooth surface without depressions and projections. The volume of air contained in the three-dimensional netlike structure 30 is 90% or more of the volume of the space occupied by three-dimensional netlike structure 30. In other words, the volume of three-dimensional netlike structure 30 is less than 10% of the volume of the space occupied by three-dimensional netlike structure 30.

Three-dimensional netlike structure 30 includes a material selected from the group consisting of a resin, a metal, and glass. When three-dimensional netlike structure 30 is formed with a resin, it may be configured from a thermoplastic elastic resin, such as a polyester or polyethylene material. More specifically, three-dimensional netlike structure 30 includes a polyester elastomer, a polyamide elastomer, a polyurethane elastomer, or a polyolefin elastomer, for example.

The surface of three-dimensional netlike structure 30 may have a second color having a color difference ΔE smaller than a predetermined threshold, the color difference being calculated with reference to a first color that the surface of structure 14 close to room space S100 has. This ensures that the surface of three-dimensional netlike structure 30 has a color tone equal to that of the surface of structure 14 close to room space S100. Three-dimensional netlike structure 30 may have light shielding properties without light transparency.

When the first color is measured in a plurality of positions on the surface of structure 14, color difference ΔE of the second color from the average of the measured first colors may be smaller than a predetermined threshold. Although the first color is measured in a plurality of positions on the surface of structure 14, the measurement may be performed in any one position thereon. Color difference ΔE is an index indicating a difference in color and represented by a distance between two points on a color space. Color difference ΔE is an index represented by an Euclidean distance between two points on the Lab color space, for example. The color difference may be a value calculated using any one of CIE76 (ΔE76), CIE94 (ΔE94), and CIEDE2000 (ΔE00) specified by Commission Internationale de I'Eclairage (CIE).

Second part 12 defines inner space S12. Inner space S12 includes first loudspeaker 21. First loudspeaker 21 may be a woofer, for example. Two third parts 13 each define inner space S13. Each inner space S13 includes second loudspeaker 22. Two second loudspeakers 22 may be a full-range loudspeaker, for example. Thus, first loudspeaker 21 and two second loudspeakers 22 may have different reproduction bandwidths.

Two second loudspeakers 22 may have the same reproduction bandwidth. In this case, one of two second loudspeakers 22 may be one example of a first loudspeaker, and the other thereof may be one example of a second loudspeaker.

First part 11 is disposed close to room space S100 with respect to second part 12 and two third parts 13 (in other words, in the Z-axis minus direction or a lower portion of the building material). Two third parts 13 are disposed in positions in the X-axial direction to sandwich second part 12 therebetween. In other words, second part 12 and two third parts 13 are disposed on the Z-axis plus direction side with respect to first part 11 and aligned in the X-axial direction in the order of one third part 13, second part 12, and the other third part 13. Inner space S12 of second part 12 is separated from inner spaces S13 of two third parts 13 by partition plate 18. Inner space S11 of first part 11, inner space S12 of second part 12, and inner spaces S13 of two third parts 13 are separated by partition plate 17.

Partition plate 17 includes three openings 17a and 17b. Opening 17a is disposed in a position in communication with inner space S11 and inner space S12. First loudspeaker 21 is fixed to partition plate 17 such that a vibration plate (not illustrated) of first loudspeaker 21 is exposed from opening 17a to inner space S11. In this configuration, first loudspeaker 21 is disposed in inner space S12 to radiate sounds toward inner space S11.

Two openings 17b each are disposed in a position in communication with inner space S13 and inner space S11. Each second loudspeaker 22 is fixed to partition plate 17 such that a vibration plate (not illustrated) of second loudspeaker 22 is exposed from opening 17b to inner space S11. In this configuration, each second loudspeaker 22 is disposed in inner space S13 to radiate sounds toward inner space S11.

Opening 17a and two openings 17b disposed in partition plate 17 are opposite to opening 15 and two openings 16 disposed in structure 14, respectively. Thus, first loudspeaker 21 and two second loudspeakers 22 are arranged in positions opposite to opening 15 and two openings 16 disposed in structure 14, respectively. First loudspeaker 21 and two second loudspeakers 22 are arranged in inner space S12 and two inner spaces S13 on the side opposite to room space S100 with respect to structure 14. Inner space S12 and two inner spaces S13 each are one example of a second space.

Inner space S11 is disposed between structure 14 and partition plate 17. Thus, three-dimensional netlike structure 30 is disposed between (i) structure 14 and (ii) first loudspeaker 21 and two second loudspeakers 22.

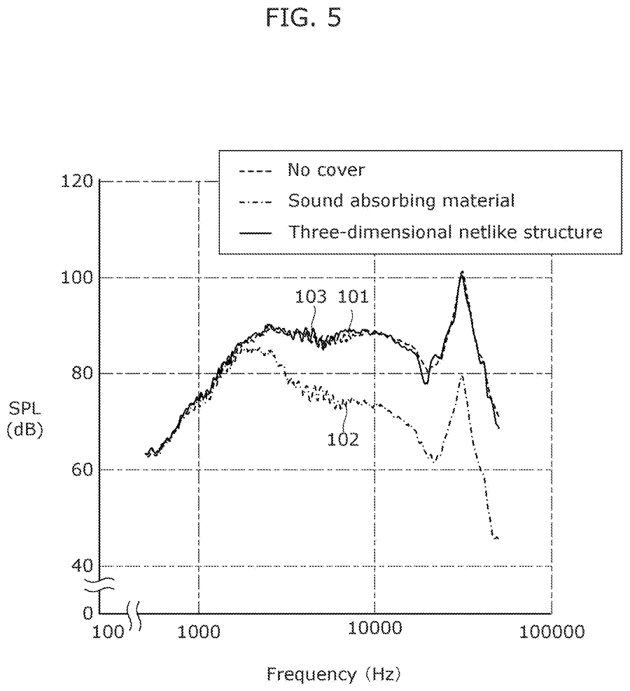

FIG. 5 is a graph showing the acoustic properties of the building material. In FIG. 5, dashed line graph 101 represents the acoustic properties of the building material without anything disposed in inner space S11, dashed-and-dotted line graph 102 represents the acoustic properties of the building material when a sound absorbing material is disposed in inner space S11, and three-dimensional line graph 103 represents the acoustic properties of building material 1 when three-dimensional netlike structure 30 is disposed in inner space S11.

FIG. 5 shows that in a frequency bandwidth of above 1000 Hz, the level of dashed-and-dotted line graph 102 representing the acoustic properties of the building material when the sound absorbing material is disposed in inner space S11 is reduced compared to that of dashed line graph 101 representing the acoustic properties of the building material without anything disposed in inner space S11. In contrast, the level of three-dimensional line graph 103 representing the acoustic properties of building material 1 substantially corresponds to that of dashed line graph 101 representing the acoustic properties of the building material without anything disposed in inner space S11. This reveals that the acoustic performance of building material 1 is hardly different from that of the building material without anything disposed in inner space S11.

Building material 1 according to the present embodiment includes three-dimensional netlike structure 30 disposed between structure 14 and first loudspeaker 21. This arrangement can reduce visibility of first loudspeaker 21 in room space S100 from a user. Due to its high acoustic transparency, three-dimensional netlike structure 30, even when disposed in the front of first loudspeaker 21, hardly reduces the acoustic performance of first loudspeaker 21. Thus, the appearance of building material 1 and the acoustic performance of sounds radiated from first loudspeaker 21 can be improved at the same time.

Moreover, building material 1 according to the present embodiment further includes second loudspeaker 22 disposed in inner space S13, in a position opposite to opening 16. Three-dimensional netlike structure 30 is disposed between (i) structure 14 and (ii) first loudspeaker 21 and second loudspeakers 22. Thus, the appearance of building material 1 and the acoustic performance of sounds radiated from first loudspeaker 21 and second loudspeakers 22 can be improved at the same time.

Moreover, in building material 1 according to the present embodiment, the surface of three-dimensional netlike structure 30 has a second color having a color difference smaller than a predetermined threshold, the color difference being calculated with reference to the first color that the surface of structure 14 close to room space S100 has. Such a configuration can make first loudspeaker 21 or second loudspeakers 22 less prominent, thus further improving the appearance of building material 1.

In building material 1 according to the present embodiment, the volume of three-dimensional netlike structure 30 is 10% or less of the volume of inner space S11 occupied by three-dimensional netlike structure 30. Thus, three-dimensional netlike structure 30 can efficiently transmit sounds from first loudspeaker 21 and second loudspeakers 22.

Moreover, in building material 1 according to the present embodiment, first loudspeaker 21 has a reproduction bandwidth different from those of second loudspeakers 22. Thus, even when sounds in a wider reproduction bandwidth are radiated, the acoustic performance can be improved.

Moreover, in building material 1 according to the present embodiment, two second loudspeakers 22 have the same reproduction bandwidth. In this case, for example, even if the radiated sounds are sounds from a sound source having multiple channels, the acoustic performance can be improved.

### Modification 1

In the embodiment above, an example in which building material 1 is disposed on a ceiling has been described. In this example, structure 14 defines part of the ceiling. Alternatively, structure 14 may define part of a wall surface. When structure 14 may define part of a wall surface, for example, the Z-axial direction in the above embodiment corresponds to the transverse direction, and the Y-axial direction corresponds to the vertical direction. Structure 14 of building material 1 may define part of a partition.

Alternatively, structure 14 may define part of a floor surface. When structure 14 defines part of a floor surface, for example, the Z-axis plus direction in the above embodiment corresponds to the lower direction and the Z-axis minus direction corresponds to the upper direction.

### Modification 2

Although building material 1 in the above embodiment includes first loudspeaker 21 and two second loudspeakers 22, building material 1 may include one loudspeaker.

### Modification 3

Although the surface of three-dimensional netlike structure 30 in the above embodiment has the second color and has light shielding properties, three-dimensional netlike structure 30 can have any other configuration. Three-dimensional netlike structure 30 may include a transparent or semi-transparent material. Even in such a case, the visibility of first loudspeaker 21 and two second loudspeakers 22 from a user in room space S100 can also be reduced.

### Modification 4

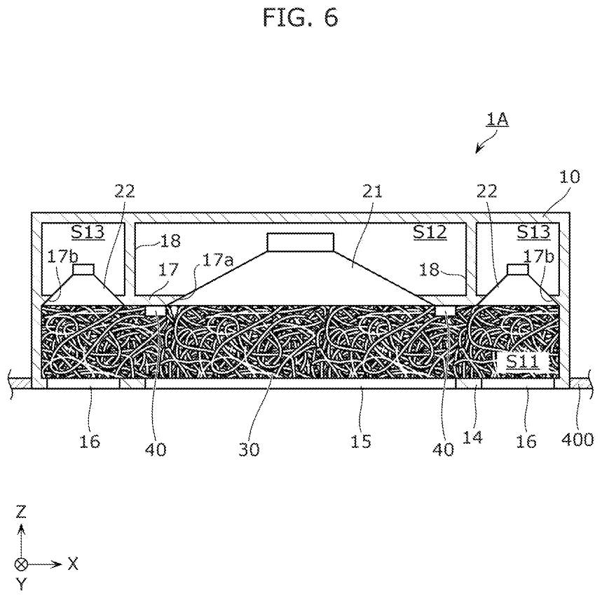

Building material 1A according to Modification 4 will be described with reference to FIG. 6. FIG. 6 is a cross-sectional view of building material 1A according to Modification 4, which corresponds to the cross-sectional view taken along IV-IV in FIG. 2.

Building material 1A further includes light source 40 in addition to the configuration of building material 1 according to the embodiment. Light source 40 is disposed across three-dimensional netlike structure 30 from structure 14, in a position opposite to opening 15. Light source 40 is a light emitting diode (LED), for example. Light source 40 is not limited to the LED, and may be an electric bulb or a fluorescent lamp.

Three-dimensional netlike structure 30 includes a transparent or semi-transparent material. By emission from light source 40, building material 1A can radiate light passing through three-dimensional netlike structure 30 from opening 15 to room space S100. Moreover, opening 15 can be colored with a variety of colors by changing the color of the light from light source 40, for example. By configuring structure 14 from a transparent or semi-transparent material, not only opening 15 but also structure 14 can have the same color of the light emitted from light source 40. This can make the position of opening 15 less prominent.

Light source 40 may be disposed close to structure 14 of three-dimensional netlike structure 30, rather than opposite to structure 14 of three-dimensional netlike structure 30. Light source 40 may be disposed in opening 15, for example.

Moreover, building material 1A may include one light source 40, rather than a plurality of light sources 40.

### Modification 5

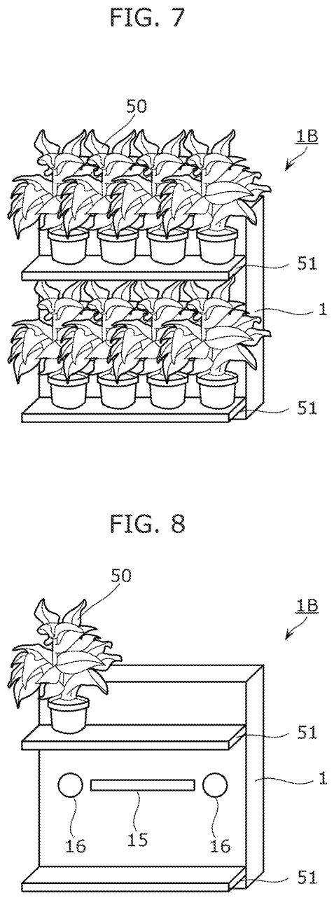

Building material 1B according to Modification 5 will be described with reference to FIGS. 7 and 8. FIG. 7 is a perspective view of the appearance of building material 1B according to Modification 5. FIG. 8 is a perspective view of the appearance of building material 1B according to Modification 5, from which part of foliage plants 50 is removed.

As illustrated in FIGS. 7 and 8, building material 1B includes building material 1 according to the embodiment, shelves 51 arranged in structure 14 of building material 1, and foliage plants 50 arranged on each of shelves 51. In building material 1B, the visibility of first loudspeaker 21 and two second loudspeakers 22 in room space S100 from a user can be further reduced by foliage plants 50 arranged on structure 14 of building material 1 close to room space S100.

Building material 1B is installed on a wall surface. Building material 1B may be embedded into the wall surface as in building material 1. Building material 1B may be attached onto the wall surface, or may be projected therefrom.

In the configuration illustrated in FIGS. 7 and 8, pots containing foliage plants 50 are placed on shelves 51. Alternatively, openings may be disposed in shelves 51, and the pots containing foliage plants 50 may be placed into the openings.

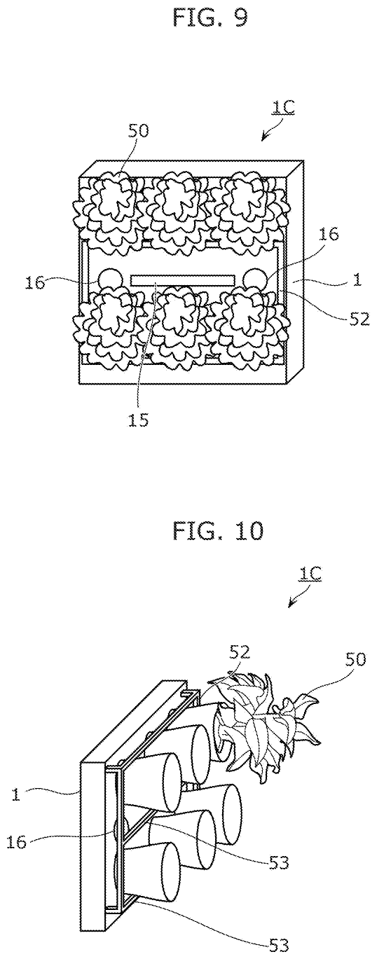

Another configuration illustrated in FIGS. 9 and 10 may be used. FIG. 9 is a perspective view of the appearance of building material 1C in another form according to Modification 5, which is viewed from the front thereof FIG. 10 is a perspective view of the appearance of building material 1C in another form according to Modification 5 viewed from a lateral surface side, where part of foliage plants 50 is removed.

As illustrated in FIGS. 9 and 10, building material 1C includes building material 1 according to the embodiment, frame-like member 52 fixed to structure 14 of building material 1, and foliage plants 50 arranged in frame-like member 52. Frame-like member 52 includes two rod-like members 53 which horizontally hold pots containing foliage plants 50. Thus, frame-like member 52 can horizontally hold foliage plants 50 with two rod-like members 53.

Foliage plants 50 may be natural plants, or may be artificial foliage plants.

In building materials 1B and 1C according to Modification 5, the surface of structure 14 close to room space S100 may be colored with the color of leaves of foliage plants 50.

As above, the building materials according to one or a plurality of aspects of the present disclosure have been described based on the embodiment, this embodiment should not be construed as limitations to the present disclosure. One or a plurality of aspects of the present disclosure also cover a variety of modifications of the present embodiment conceived and made by persons skilled in the art and embodiments including combinations of components in different embodiments without departing from the gist of the present disclosure.

### INDUSTRIAL APPLICABILITY

The present disclosure is useful as a building material which can ensure both an improved appearance of the building material and improved acoustic performance of sounds radiated from the loudspeaker at the same time.

1. A building material facing a first space, the building material comprising:
a structure which is in a plate form and includes at least one opening;
a first loudspeaker disposed in a second space across the structure from the first space, in a position opposite to a corresponding one of the at least one opening; and
a three-dimensional netlike structure disposed between the structure and the first loudspeaker, and is configured with a fibrous member three-dimensionally intertwined.

2. The building material according to claim 1,
wherein the three-dimensional netlike structure has a surface of a second color having a color difference smaller than a predetermined threshold, the color difference being calculated with reference to a first color that a surface of the structure close to the first space has.

3. The building material according to claim 1,
wherein the three-dimensional netlike structure comprises a material selected from the group consisting of a resin, a metal, and glass.

4. The building material according to claim 1,
wherein the three-dimensional netlike structure comprises a transparent or semi-transparent material.

5. The building material according to claim 1, further comprising:
a light source disposed across the three-dimensional netlike structure from the structure, in a position opposite to a corresponding one of the at least one opening.

6. The building material according to claim 1,
wherein a volume of the three-dimensional netlike structure is 10% or less of a volume of a third space occupied by the three-dimensional netlike structure.

7. The building material according to claim 1, further comprising:
a second loudspeaker disposed in the second space, in a position opposite to a corresponding one of the at least one opening,
wherein the three-dimensional netlike structure is disposed between (1) the structure and (ii) the first loudspeaker and the second loudspeaker.

8. The building material according to claim 7,
wherein the first loudspeaker and the second loudspeaker have a same reproduction bandwidth.

9. The building material according to claim 7,
wherein the first loudspeaker and the second loudspeaker have different reproduction bandwidths.
